(19) United States
(12) Patent Application Publication
(10) Pub. No.: US 2025/0237435 A1
(43) Pub. Date: Jul. 24, 2025

(54) DRYING TREATMENT APPARATUS

(71) Applicant: TOYOTA JIDOSHA KABUSHIKI KAISHA, Toyota-shi (JP)

(72) Inventors: Kazuki NORITAKE, Nisshin-shi (JP); Kenichiro Muramatsu, Toyota-shi (JP); Junichi Ishimoto, Okazaki-shi (JP); Yasushi Kato, Toyota-shi (JP)

(73) Assignee: TOYOTA JIDOSHA KABUSHIKI KAISHA, Toyota-shi (JP)

(21) Appl. No.: 18/925,416

(22) Filed: Oct. 24, 2024

(30) Foreign Application Priority Data
Jan. 18, 2024 (JP) 2024-006234

(51) Int. Cl. F26B 11/04; H01M 10/54

(52) U.S. Cl. CPC F26B 11/0481; H01M 10/54

(57) ABSTRACT

A drying treatment apparatus includes: a housing having a charging port for charging crushed pieces, and a discharging port for discharging the crushed pieces; a screw conveyor including a screw blade provided in an internal space of the housing, and a driving device that drives the screw blade, the screw conveyor conveying the crushed pieces charged through the charging port to the discharging port using a pushing-out action of the screw blade; and a heater that heats the housing. In the drying treatment apparatus, the driving device drives the screw blade while the heater is heating the housing.

### CROSS-REFERENCE TO RELATED APPLICATION

This application claims priority to Japanese Patent Application No. 2024-006234 filed on Jan. 18, 2024, incorporated herein by reference in its entirety.

### BACKGROUND

### 1. Technical Field

The present disclosure relates to a technique that performs drying treatment on crushed pieces of batteries containing an electrolyte such that the electrolyte vaporizes.

### 2. Description of Related Art

Japanese Unexamined Patent Application Publication No. 2023-052213 (JP 2023-052213 A) discloses a technique relating to a method for treating used lithium ion batteries. JP 2023-052213 A discloses the method for treating lithium ion batteries including a step of performing drying treatment on crushed pieces (comminuted material) of lithium ion batteries, and a step of conveying the dried crushed pieces to a transport container using conveying equipment (conveyor).

In addition to this, examples of the documents that show the state of the art in the technical field relating to the present disclosure include Japanese Unexamined Patent Application Publication No. 8-117719, Japanese Unexamined Patent Application Publication No. 2003-200146, and Japanese Unexamined Patent Application Publication No. 2002-273400.

### SUMMARY

As disclosed in JP 2023-052213 A, there is a method including a step of performing drying treatment for removing an electrolyte contained in crushed pieces of batteries as a method for treating used batteries. The drying treatment is a treatment that requires not a small amount of time because sufficient removal of the electrolyte is required. Thus, in such a treatment method, a step of performing drying treatment and a step of performing conveyance until the next treatment step may become rate-determining processes. One object of the present disclosure is to provide a technique that enables step shortening in a treatment method including a step of performing drying treatment.

One aspect of the present disclosure relates to a drying treatment apparatus that vaporizes an electrolyte contained in crushed pieces of batteries. The drying treatment apparatus includes: a housing having a charging port for charging the crushed pieces, and a discharging port for discharging the crushed pieces; a screw conveyor including a screw blade provided in an internal space of the housing, and a driving device that drives the screw blade, the screw conveyor conveying the crushed pieces charged through the charging port to the discharging port using a pushing-out action of the screw blade; and a heater that heats the housing. In the drying treatment apparatus, the driving device drives the screw blade while the heater is heating the housing.

According to the present disclosure, the drying treatment apparatus can convey the crushed pieces charged into the housing from the charging port to the discharging port while performing the drying treatment to vaporize the electrolyte from the crushed pieces. Accordingly, the drying treatment step and the conveyance step can be integrated together. As a result, in the treatment method including the drying treatment step, it is possible to achieve effective step shortening.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing the configuration of a drying treatment apparatus according to an embodiment;

FIG. 2 is a diagram showing the operation of the drying treatment apparatus according to the embodiment based on the configuration shown in FIG. 1; and

FIG. 3 is a diagram for describing a configuration for efficiently heating crushed pieces in the drying treatment apparatus according to the embodiment.

### DETAILED DESCRIPTION OF EMBODIMENTS

Hereinbelow, an embodiment of the present disclosure will be described with reference to the drawings. Note that the same or corresponding parts in the drawings are denoted by the same reference signs to simplify or omit description thereof.

### 1. Overview

Used batteries are treated through various treatment steps for the purpose of recycling or disposal. In particular, the treatment of used batteries requires proper removal and collection of an electrolyte contained in the batteries. For this purpose, as a method for treating used batteries, there is a treatment method including a treatment step (drying treatment step) of drying crushed pieces of crushed batteries to vaporize an electrolyte contained in the crushed pieces. The drying treatment step includes maintaining the crushed pieces of the batteries in an atmosphere of a temperature and a pressure corresponding to electrolyte vaporization conditions. The present embodiment relates to a drying treatment apparatus for performing the drying treatment step.

In shifting from one treatment step to the next treatment step, an object to be treated is typically conveyed from a treatment apparatus for the one treatment step to a treatment apparatus for the next treatment step. That is, between the treatment steps, a step (conveyance step) of conveying the object to be treated is typically present.

A drying treatment apparatus according to the present embodiment makes it possible to integrate a drying treatment step and a conveyance step together in a treatment method including the drying treatment step. The drying treatment step is a treatment step that requires not a small amount of time to sufficiently remove the electrolyte. Thus, integrating the drying treatment step and the conveyance step together achieves effective step shortening in the entire treatment. Hereinbelow, the drying treatment apparatus according to the present embodiment will be described in detail.

### 2. Drying Treatment Apparatus

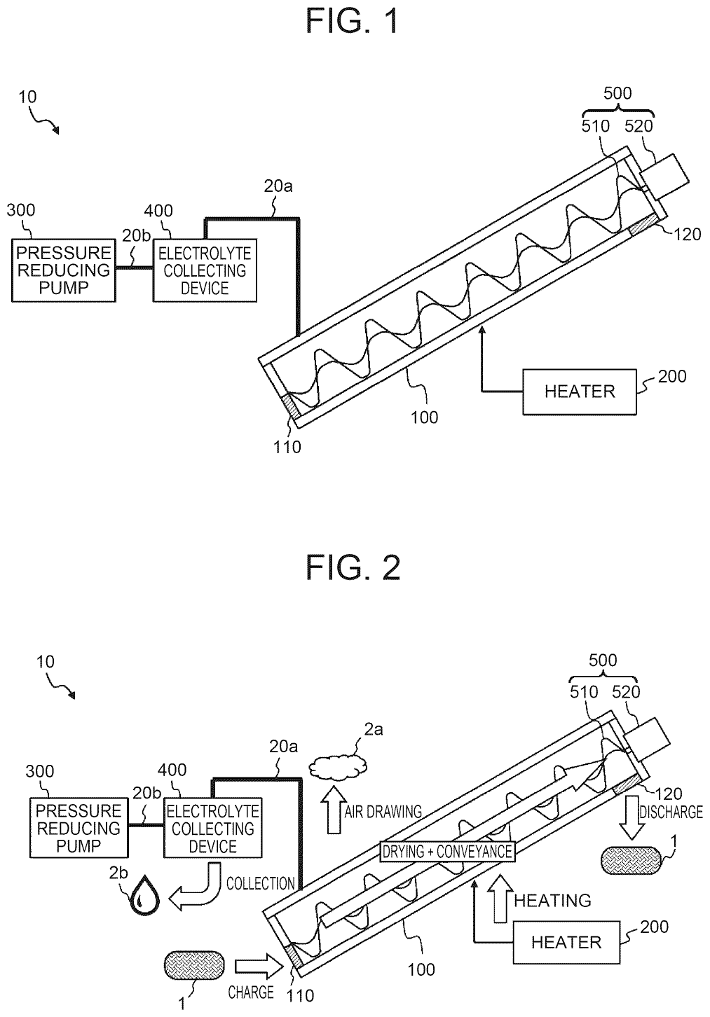

FIG. 1 is a diagram showing the configuration of a drying treatment apparatus 10 according to the present embodiment. FIG. 2 shows the operation of the drying treatment apparatus 10 according to the present embodiment based on the configuration shown in FIG. 1.

The drying treatment apparatus 10 according to the present embodiment includes a housing 100, a heater 200, a pressure reducing pump 300, an electrolyte collecting device 400, and a screw conveyor 500.

The housing 100 is provided with a screw blade 510 of the screw conveyor 500, which will be described further below, in its internal space and has a shape extending in the axial direction of the screw blade 510. The housing 100 is formed of, for example, a steel material having high thermal conductivity. In particular, a part of the internal space of the housing 100 may be curved downward to obtain sufficient pressure resistance. More specifically, the internal space may be formed such that, when the housing 100 is cut in a direction perpendicular to the axial direction of the screw blade 510, a bottom wall face and left and right side wall faces that define the internal space have a U-shape. FIGS. 1 and 2 show side views of the housing 100 illustrating the internal space. In actuality, a ceiling wall face that defines the internal space is provided. In addition, FIGS. 1 and 2 show a case in which the housing 100 is installed in a slanted state. However, in the drying treatment apparatus 10 according to the present embodiment, the installation state of the housing 100 can be changed as appropriate.

The housing 100 has a charging port 110, and a discharging port 120. The charging port 110 and the discharging port 120 are provided at the respective positions near opposite ends of the screw blade 510. In FIGS. 1 and 2, the charging port 110 is provided at a front face of the housing 100 on the left end side of the screw blade 510. The discharging port 120 is provided at a bottom face of the housing 100 on the right end of the screw blade 510. The positions of the charging port 110 and the discharging port 120 may be changed as appropriate.

Crushed pieces 1 of batteries containing an electrolyte are charged into the housing 100 through the charging port 110. The crushed pieces 1 are, for example, obtained by crushing the batteries in a frozen state in a previous treatment step. Examples of the battery to be crushed include a lithium-ion battery, a nickel metal hydride battery, and a nicad battery. To facilitate charging of the crushed pieces 1, a hopper may be connected to the charging port 110.

The crushed pieces 1 charged into the housing 100 are the object to be treated by the drying treatment apparatus 10. In the drying treatment apparatus 10, the heater 200 and the pressure reducing pump 300 are driven to perform drying treatment to vaporize the electrolyte from the crushed pieces 1.

The heater 200 heats the housing 100. The structure of the heater 200 is not limited to any particular structure. For example, the heater 200 includes a heating wire. The heater 200 is driven such that the temperature in the internal space of the housing 100 rises to a certain temperature corresponding to the electrolyte vaporization conditions.

The pressure reducing pump 300 is connected to the internal space of the housing 100 through a pipe 20a and a pipe 20b. Note that the electrolyte collecting device 400 is provided between the housing 100 and the pressure reducing pump 300. The action of the electrolyte collecting device 400 will be described further below.

The pressure reducing pump 300 is a pump that reduces the pressure in the internal space of the housing 100. The pressure reducing pump 300 can also be called a “vacuum pump”. The pressure reducing pump 300 draws air from the housing 100 through the pipe 20a and the pipe 20b to reduce the pressure in the internal space of the housing 100. The pressure reducing pump 300 is driven such that the pressure in the internal space of the housing 100 is reduced to a certain pressure corresponding to the electrolyte vaporization conditions while the heater 200 is heating the housing 100.

The heating performed by the heater 200 and the pressure reduction performed by the pressure reducing pump 300 maintain the internal space of the housing 100 at the temperature and the pressure that cause the electrolyte contained in the crushed pieces 1 to vaporize. Thus, by the temperature of the crushed pieces 1 charged into the housing 100 rising to the maintained temperature, the electrolyte gradually vaporizes from the crushed pieces 1. In this manner, the drying treatment to vaporize the electrolyte contained in the crushed pieces 1 is performed in the drying treatment apparatus 10.

In the drying treatment apparatus 10, the electrolyte removed from the crushed pieces 1 by the drying treatment is further collected by the action of the electrolyte collecting device 400.

The electrolyte collecting device 400 is connected to the pipe 20a and the pipe 20b, and provided between the housing 100 and the pressure reducing pump 300. An electrolyte 2a in a gaseous state vaporized by the drying treatment flows into the electrolyte collecting device 400 through the pipe 20a by the pressure reducing pump 300 drawing air. The electrolyte collecting device 400 is maintained at a temperature and a pressure that cause the electrolyte 2a in a gaseous state to condense. That is, the electrolyte collecting device 400 condenses the flowed-in electrolyte 2a in a gaseous state. The electrolyte collecting device 400 then collects the condensed electrolyte 2b. In this manner, the drying treatment apparatus 10 can collect the electrolyte removed from the crushed pieces 1 through the drying treatment.

In the drying treatment apparatus 10, the screw conveyor 500 further conveys the crushed pieces 1 from the charging port 110 to the discharging port 120 during the drying treatment of the crushed pieces 1.

The screw conveyor 500 includes the screw blade 510, and a driving device 520. The screw blade 510 is provided in the internal space of the housing 100 and rotatable around an axis. The screw blade 510 is formed of, for example, a steel material having high thermal conductivity as with the housing 100. The driving device 520 drives the screw blade 510. The driving device 520 is, for example, an electric motor that is mounted to rotate the screw blade 510 around the axis.

When the driving device 520 drives the screw blade 510, the screw blade 510 acts to push out the crushed pieces 1 in the internal space of the housing 100 in the axial direction. The screw conveyor 500 conveys the crushed pieces 1 from the charging port 110 to the discharging port 120 using this pushing-out action of the screw blade 510.

In the present embodiment, in particular, a shaftless screw conveyor can be used as the screw conveyor 500. That is, the screw blade 510 is formed with no shaft. Each of the crushed pieces 1 charged into the housing 100 may have a certain degree of grain size, and the grain sizes of the crushed pieces 1 may differ from each other. In such a case, the shaftless screw conveyor 500 makes it possible to prevent the crushed pieces 1 from becoming entangled with the screw blade 510 while the crushed pieces 1 are being conveyed and perform smooth conveyance. However, depending on the degree of the grain sizes of the crushed pieces 1, a shafted screw conveyor may be used as the screw conveyor 500.

In the drying treatment apparatus 10, the driving device 520 drives the screw blade 510 while the heater 200 is heating the housing 100. Accordingly, the crushed pieces 1 are conveyed from the charging port 110 to the discharging port 120 while being subjected to the drying treatment. The driving device 520 may be controlled by a control device (not shown) to ensure that the drying treatment of the crushed pieces 1 is sufficiently performed during conveyance. For example, the control device controls the driving device 520 to adjust the rotation speed of the screw blade 510 such that the conveyance time satisfies the treatment time of the drying treatment. In addition, for example, the control device controls the driving device 520 to adjust the rotation speed of the screw blade 510 in accordance with the amount of the electrolyte collected by the electrolyte collecting device 400.

The crushed pieces 1 conveyed while being subjected to the drying treatment are discharged from the housing 100 through the discharging port 120. In this manner, in the drying treatment apparatus 10, the crushed pieces 1 are conveyed from the charging port 110 to the discharging port 120 during the drying treatment of the crushed pieces 1.

As described above, in the drying treatment apparatus 10, the housing 100 in which the drying treatment is performed on the crushed pieces 1 also serves as a conveyance path from the charging port 110 to the discharging port 120. Thus, the drying treatment apparatus 10 can perform the drying treatment step and can also perform the conveyance step from the previous treatment step to the next treatment step. For example, the charging port 110 can be connected to a discharging port of a treatment apparatus for the previous treatment step, and the discharging port 120 can be connected to a charging port of a treatment apparatus for the next treatment step. In this manner, according to the drying treatment apparatus 10 of the present embodiment, the drying treatment step and the conveyance step can be integrated together. As a result, in the treatment method including the drying treatment step, it is possible to achieve effective step shortening in the entire treatment.

In the drying treatment apparatus 10 of the present embodiment, the drying treatment is performed by heating, in the internal space of the housing 100 maintained at a certain temperature, the crushed pieces 1 to the certain temperature. However, since the internal space of the housing 100 is under a reduced pressure, a sufficient temperature rise may not be obtained merely by heating the crushed pieces 1 in the atmosphere. Thus, hereinbelow, a configuration for more efficiently heating the crushed pieces 1 in the drying treatment apparatus 10 according to the present embodiment will be proposed.

### 3. Configuration for Efficiently Heating Crushed Pieces

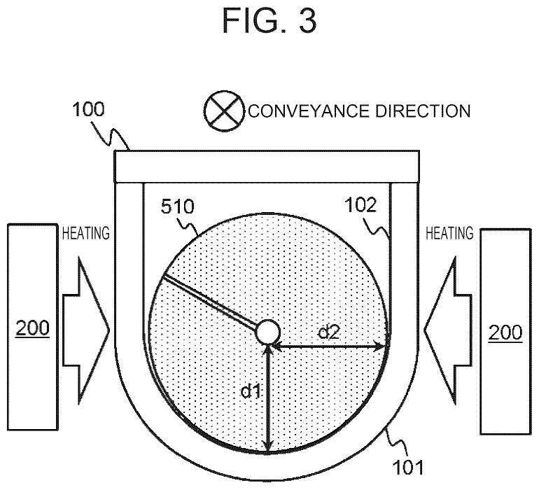

FIG. 3 is a diagram for describing the configuration for efficiently heating the crushed pieces 1 in the internal space of the housing 100. FIG. 3 is a sectional view of the housing 100 taken in a direction perpendicular to the axial direction of the screw blade 510, and also a sectional view of the housing 100 viewed from the front of the charging port 110.

First, in the configuration shown in FIG. 3, the heater 200 is configured to heat an outer wall face 101 of the housing 100 extending in the axial direction of the screw blade 510 (the conveyance direction of the screw conveyor 500). For example, the heater 200 includes a heating wire installed throughout the entire outer wall face 101 of the housing 100.

Next, in the configuration shown in FIG. 3, the bottom wall face constituting an inner wall face 102 of the housing 100 is convexly curved toward the lower side of the housing 100, so that the bottom wall face and the left and right side wall faces that constitute the inner wall face 102 have a U-shape in cross section. An outer edge portion of the screw blade 510 is configured to be in contact with the bottom wall face. In FIG. 3, a lower part of the outer edge portion of the screw blade 510 is in contact with the curved portion of the bottom wall face.

The entire wall face extending in the axial direction of the screw blade 510 of the housing 100 is heated by the heater 200. Thus, since the outer edge portion of the screw blade 510 is in contact with the curved portion of the bottom wall face, heat is efficiently transferred from the housing 100. As a result, the screw blade 510 is brought into a state heated to a temperature approximately equal to the temperature of the housing 100.

In this manner, according to the configuration shown in FIG. 3, the entire outer wall face 101 of the housing 100 is heated by the heater 200 in the axial direction of the screw blade 510. In addition, since the outer edge portion of the screw blade 510 is in contact with the curved portion of the bottom wall face, the screw blade 510 is heated to a temperature approximately equal to the temperature of the housing 100. Accordingly, in the internal space of the housing 100, the crushed pieces 1 are heated by both the housing 100 and the screw blade 510 that serve as heat sources between the charging port 110 and the discharging port 120. In this manner, according to the configuration described with reference to FIG. 3, it is possible to efficiently heat the crushed pieces 1.

In order to more efficiently heat the crushed pieces 1, the housing 100 may be configured such that the distance between the crushed pieces 1 and the inner wall face 102 of the housing 100 is a certain distance or less. Heat transfer to the crushed pieces 1 may become weaker as the distance from the inner wall face 102 of the housing 100 increases. Thus, the configuration in which the distance between the crushed pieces 1 and the inner wall face 102 is the certain distance or less makes it possible to prevent heating of some of the crushed pieces 1 from becoming insufficient. It is assumed that, due to the action of the screw blade 510, the crushed pieces 1 are located below the center of the screw blade 510 in the internal space of the housing 100. Thus, this configuration can be achieved by reducing a distance dl (the distance in the vertical direction from the center of the screw blade 510 to the bottom face of the housing 100) and a distance d2 (the distance in the horizontal direction from the center of the screw blade 510 to the side face of the housing 100) shown in FIG. 3 to a certain distance or less. For example, the housing 100 is configured such that each of the distances d1 and d2 is 100 mm or less.

What is claimed is:

1. A drying treatment apparatus that vaporizes an electrolyte contained in crushed pieces of batteries, the drying treatment apparatus comprising:
a housing having a charging port for charging the crushed pieces, and a discharging port for discharging the crushed pieces;
a screw conveyor including a screw blade provided in an internal space of the housing, and a driving device that drives the screw blade, the screw conveyor conveying the crushed pieces charged through the charging port to the discharging port using a pushing-out action of the screw blade; and
a heater that heats the housing, wherein
the driving device drives the screw blade while the heater is heating the housing.

2. The drying treatment apparatus according to claim 1, further comprising a pressure reducing pump that is connected to the housing and reduces pressure in the internal space, wherein the pressure reducing pump is driven while the heater is heating the housing.

3. The drying treatment apparatus according to claim 2, further comprising an electrolyte collecting device that is provided between the housing and the pressure reducing pump, and condenses and collects the electrolyte in a gaseous state.

4. The drying treatment apparatus according to claim 1, wherein
an inner wall face of the housing defining the internal space includes a bottom wall face convexly curved toward a lower side of the housing,
the heater is configured to heat an outer wall face of the housing extending in an axial direction of the screw blade, and
an outer edge portion of the screw blade is configured to be in contact with a curved portion of the bottom wall face.

5. The drying treatment apparatus according to claim 1, wherein the screw conveyor is a shaftless screw conveyor.
